(19) United States
(12) Patent Application Publication
(10) Pub. No.: US 2021/0068495 A1
(43) Pub. Date: Mar. 11, 2021

(54) FOOTWEAR STIMULATING THE FOOT BY REFLEXOLOGY MASSAGE

(71) Applicants: Sofia TELATIN, Fontaniva (PD) (IT); FESSURA ITALIA S.R.L., Montegranaro (IT)

(72) Inventors: Sofia TELATIN, Fontaniva (PD) (IT); Andrea VECCHIOLA, Montegranaro (FM) (IT)

(73) Assignees: FESSURA ITALIA S.R.L., Montegranaro (IT); Sofia TELATIN, Fontaniva (PD) (IT)

(21) Appl. No.: 17/053,063

(22) PCT Filed: May 7, 2019
(86) PCT No.: PCT/IB2019/053743

§ 371 Date: Nov. 4, 2020

(30) Foreign Application Priority Data
May 11, 2018 (IT) 102018000005295

(51) Int. Cl. A43B 7/14; A43B 23/04; A43B 13/04; A43B 13/14; A61H 39/04

(52) U.S. Cl. CPC A43B 7/146; A43B 7/1415; A43B 23/042; A43B 13/04; A61H 2205/125; A61H 39/04; A61H 2201/164; A61H 2201/165; A43B 13/141

(57) ABSTRACT

The present invention refers to a footwear consisting of an upper portion and a sole, wherein the upper portion is provided with a soft and flexible deconstructed plantar area able to allow the foot to rest on it, once the footwear has been worn, and the sole is fixed to the upper portion below the plantar area and is provided with a plurality of flexible bearings, arranged in correspondence with respective sensitive areas for the plantar reflexology massage.

### FIELD OF THE INVENTION

The present invention relates to a footwear. In particular, the present invention refers to a footwear suitable for transmitting the benefits of a foot reflexology massage.

### STATE OF THE ART

Foot reflexology is a technique by which the body's energy balance is restored, using a particular type of massage which, through the stimulation and compression of specific reflex points on the feet, energetically related to organs and devices, allows the exercise of preventive and intervention action on possible organism imbalances.

Some footwear are known in art that attempt to stimulate such a foot reflexology massage; these footwear have an insole, the part onto which the foot typically rests, which is provided with single raised points that determine the massage activation upon pressure generated on them by the foot during walking.

However, such footwear has several disadvantages.

First of all, the fact that these footwear have single points in relief for the massage activation can create pain for the user; in fact, since each individual has his own foot conformation, the stimulation points that activate the massage change from person to person. Consequently, having produced a footwear having a specific positioning of the massage activation points can be harmful for many users with a plantar conformation not suitable for such a footwear.

Moreover, in known in the art footwear, the foot comes into direct contact with the part that activates the massage, typically positioned in the sole which is an integral part of the footwear. Continuous direct contact between the foot and the contact point for the massage activation in the long run can be harmful to the user foot.

Finally, the part that should stimulate the massage is made with materials that are sometimes hard and without shape memory. Consequently, the effect provided by the massage is often negligible, if not minimal or zero.

The Applicant of the present patent application has found the need to produce a footwear that solves the previous disadvantages.

### SUMMARY OF THE INVENTION

According to a first aspect, the present invention relates to a footwear as the one indicated in claim 1.

The present invention in fact arises from the general consideration according to which the technical problem highlighted above can be solved in an effective and reliable manner by means of a footwear consisting of an upper portion and a sole, wherein:
said upper portion is provided with a deconstructed plantar area, made with soft and flexible materials, suitable for allowing the foot to rest on it, once the footwear is worn;
said sole is fixed to said upper portion below and in correspondence with said deconstructed plantar area and is provided with a plurality of flexible pads, arranged in correspondence with respective sensitive areas for the foot reflexology massage.

In this way the footwear of the present invention allows to generate a reflexology massage both at rest and, more relevantly, during movement. In fact, during walking, the weight of the user who wears the footwear press onto the sensitive areas positioned in the parts of the foot plant that activate the logical reflex massage.

Moreover, since the reflexology points change from individual to individual, thanks to the fact that the flexible bearings present in the footwear of the present invention are arranged not in correspondence of single sensitive points for the feet reflexology massage, but rather in sensitive areas containing several sensitive points, with such flexible bearings it is possible to satisfy the different needs of a plurality of individuals, without any contraindication.

Moreover, the presence of the deconstructed plantar area of the upper portion, i.e. made without any kind of reinforcement, which actually separates the foot sole from the sole area where the flexible bearings are present, prevents the foot from continuously coming into contact with these pads, thus avoiding creating, for a long time, a discomfort to the foot sole.

In a preferred embodiment, said sole is formed by an outer shell to which said flexible bearings are fixed. The outer shell of the sole, which can be made of E.V.A., P.U., T.P.U. rubber, is made using classic industrial production techniques, such as compression, injection or 3D printer technology.

In a preferred embodiment, each of said flexible bearings is made of elastic material such as to compress when subjected to pressure and to reacquire the original shape when said compression ends.

In this way a footwear is obtained that perfectly adapts to the appearance of the foot of different individuals, and that is long-lasting.

In a preferred embodiment, each of said flexible bearings is made of soft materials having a shape memory. The bearings can be made with 3D printers using thermoplastic elastomers of the TPU type (such as for example the Filaflex 82A original, 175 mm, a polyether-polyurethane available from Recreus Industries SL, Alicante, Spain) or using thermoplastic elastomers of the TPE or TPC type. Moreover, the bearings can be made of pressurized air contained in bubbles of plastic material; or again the bearings can be made of E.V.A. (Ethylene Vinyl Acetate) by injection or compression.

In this way an extremely soft sole is obtained providing the user with a pleasant comfort feeling.

In a preferred embodiment, at least one flexible bearing is arranged in said sole at the sensitive area for the foot reflexology massage in the front part of the foot sole, which comprises the fingers and the underlying part. In this way, when this sensitive area is stimulated by the foot pressure, the reflexology massage is promoted to the brain and cerebellum area, placed in correspondence with the big toe, which brings to a stress relief.

In a preferred embodiment, at least one flexible bearing is arranged in said sole at the sensitive area for the foot reflexology massage in the posterior part of the foot sole (heel or calcaneus). In this way, when this sensitive area is stimulated by the foot pressure at the heel or calcaneus, relief from back pain and sciatic nerve is achieved.

In a preferred embodiment, at least one flexible bearing is disposed in said sole at the sensitive area for the foot reflexology massage placed in the upper part of the foot sole. In this way, when this sensitive area is stimulated by the foot pressure, the reflexology massage to the area of the solar plexus and the lungs is promoted, bringing benefits with regard to the anxiety and breathing control.

In a preferred embodiment, at least one flexible bearing is arranged in said sole at the sensitive area for the foot reflexology massage in the central part of the foot sole (plantar arch). In this way, when this sensitive area is stimulated by the foot pressure, the reflexology massage bringing benefits with regard to better digestion and absorption is promoted.

In a preferred embodiment, each of said flexible bearings occupies substantially the whole width of said sole, respectively in correspondence of said sensitive areas for the foot reflexology massage.

In this way, each bearing is fixed to the sole in a stable manner, supporting itself against both longitudinal edges of the footwear.

In a preferred embodiment, said flexible bearings are separated from each other so that there is empty space between one flexible bearing and the other.

In a preferred embodiment, said upper portion is constituted by a sort of bag provided with an opening at one of its ends to allow the foot insertion in the bag through said opening and the whole foot wrapping inside the bag.

In this way, it is possible to wear the footwear by passing the foot through the bag opening, which thus remains completely wrapped by the bag.

In a preferred embodiment, said bag-type upper portion can be made by working with internal longitudinal closure stitching, or with a Strobel-type stitching or with inverted stitching in the perimeter area.

Moreover, for the upper part of the footwear all suitable types of upper portion can be used, such as sandal, shoe, socket, boot, and with any type of closure suitable to meet the different design needs of consumers and companies.

In a preferred embodiment, said upper portion is constituted by a sort of sock provided with an opening at one of its ends to allow the foot insertion and the whole foot wrapping in said sock without the presence of any internal longitudinal closing seam or inverted seam in the perimeter area being it made with tubular technique by circular machines which provides a single seam at the tip.

In a preferred embodiment, the plantar area of the upper portion is made without any kind of reinforcement with flexible soft materials.

In this way, the pressure of the sole is effective and functional for the foot massage.

Further characteristics and advantages of the present invention will be better highlighted by examining the following detailed description of a preferred but not exclusive embodiment, illustrated by way of non-limiting example, with the support of the attached drawings, wherein:

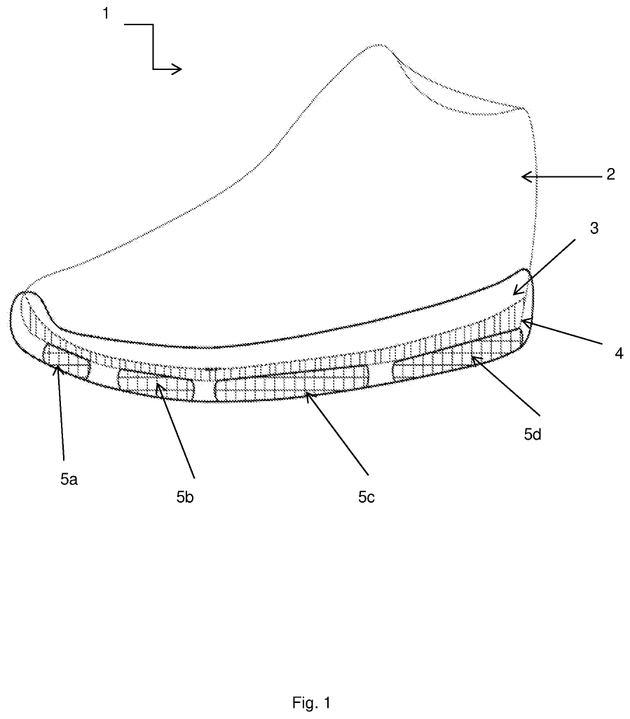

FIG. 1 is an overall view of an embodiment of a footwear according to the present invention;

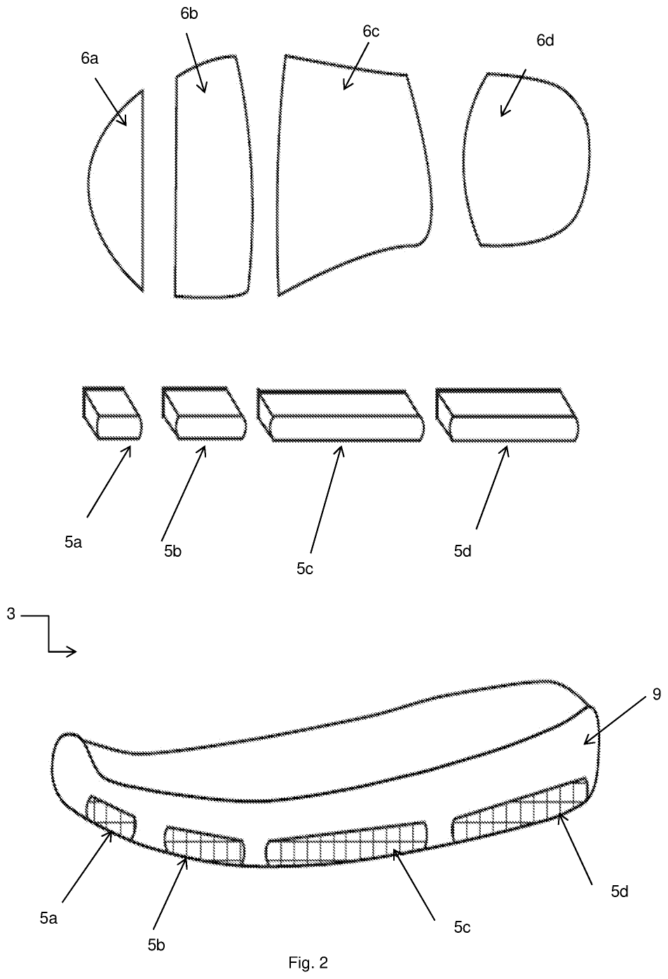

FIG. 2 is a detail of the sole of the footwear of FIG. 1;

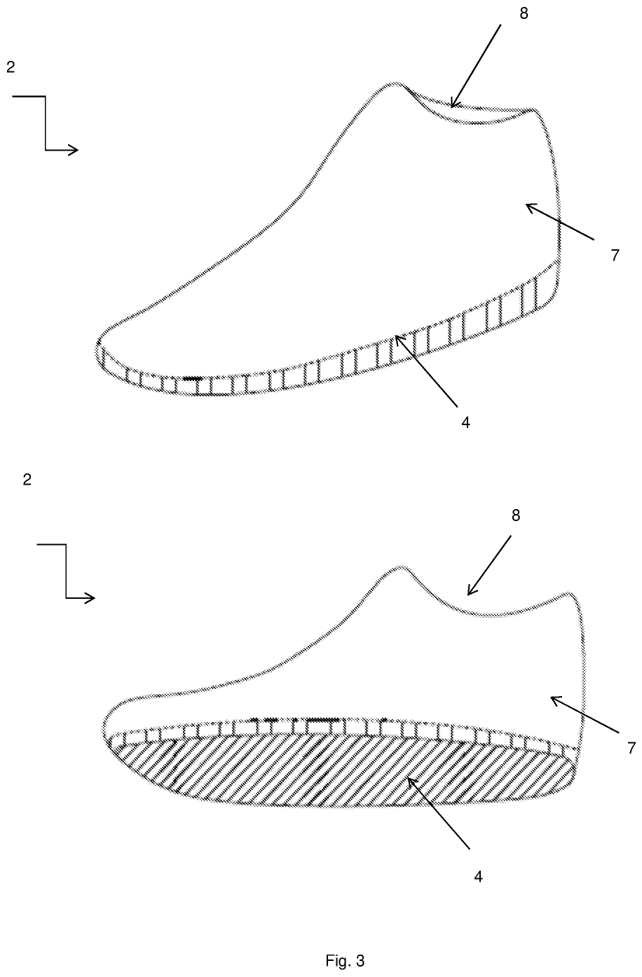

FIG. 3 shows an embodiment of the upper portion of the footwear of FIG. 1.

### DETAILED DESCRIPTION OF THE INVENTION

With reference to FIGS. 1-3, an embodiment of a footwear 1 according to the present invention is shown below.

FIG. 1 shows the footwear 1 consisting of an upper portion 2 and a sole 3, fixed to the upper portion 2.

The upper 2 portion consists of a sort of bag/sock 7, better visible in FIG. 3, provided with an opening 8 at one of its ends to allow the foot insertion in the bag/sock 7 through the opening 8. The upper portion 2 in the shape of a bag/sock 7 is also provided in its lower part with a deconstructed plantar area 4, made with soft and flexible materials, giving a certain comfort to the foot that directly rests on the plantar area 4.

The upper portion 2 is made by working with an internal longitudinal closure seam, or with a Strobel-type seam or with an inverted seam in the perimeter area or a tubular sock with the presence of a single seam at the tip.

The foot thus remains completely wrapped by the upper portion 2 in the shape of a bag/sock giving a pleasant feeling comfort to the user.

The sole 3 is applied to the lower part of the plantar area 4 of the upper portion 2, which is therefore fixed below the upper portion 2.

The sole 3 is constituted by an outer shell 9 made of plastic material such as E.V.A. Rubber, P.U., T.P.U., through the classic industrial production techniques, such as, for example, compression, injection or with 3D printer technology.

Flexible bearings 5a, 5b, 5c, 5d are fixed to the shell 9, each positioned, respectively, at a sensitive area 6a, 6b, 6c, 6d for the foot reflexology massage.

In particular, the flexible bearing 5a is placed at the sensitive area 6a for brain and cerebellum, placed at the big toe; if stimulated, or when a slight or stronger pressure is applied, stress relief is achieved. The flexible bearing 5b is placed at the sensitive area 6b of the solar plexus and of the lungs, located in the upper part of the foot sole; when stimulated, it has benefits in terms of anxiety and breathing controlling. The flexible bearing 5c is placed in correspondence of the sensitive area 6c of the digestive system area, exactly placed under the plantar arch; if stimulated, it leads to better digestion and absorption. The flexible bearing 5d is placed at the sensitive area 6d, exactly placed under the heel; if stimulated, it leads to relief from back pain and sciatic nerve.

The area of the big toe and of the solar plexus and of the lungs were made in such a way as to cover the entire foot length as a matter of stability.

Each flexible bearing 5a, 5b, 5c, 5d substantially occupies the whole width of the sole 3, so as to be fixed to the sole 3 in a stable manner, supporting itself against both the longitudinal edges of the footwear. There is a gap between each flexible bearing 5a, 5b, 5c, 5d and the other. The flexible bearings 5a, 5b, 5c, 5d have a shape, curvature and/or dimension such as to adapt to the specific needs of a single individual to obtain the maximum benefit during walking.

The flexible bearings 5a, 5b, 5c, 5d can be made with 3D printers by using thermoplastic elastomers of the TPU type (an example is the original Filaflex 82A, 175 mm, a polyether-polyurethane available from Recreus Industries SL, Alicante, Spain) or by using thermoplastic elastomers of the TPE or TPC type; they can be bearings made of pressurized air contained in plastic bubbles; they can be bearings made of E.V.A. (Ethylene Vinyl Acetate) by injection or compression.

Such materials have the property of making flexible the bearings 5a, 5b, 5c, 5d and having a memory, that means to be capable of returning to their original shape once their compression has been exhausted due to the pressure exerted on them by the foot of the user wearing the footwear 1 during walking.

The flexible bearings 5a, 5b, 5c, 5d therefore provide the user with a pleasant comfort feeling and a massaging effect.

Of course, many modifications and variations of the preferred embodiment described above will be apparent to persons skilled in the art, still remaining within the scope of the invention.

Therefore, the present invention is not limited to the preferred embodiment described, illustrated only by way of non-limiting example, but is defined by the following claims.

1. Footwear (1) consisting of an upper portion (2) and a sole (3) fixed to said upper portion (2), wherein:
said upper portion (2) is provided with a deconstructed plantar area (4), made with soft and flexible materials, suitable for allowing the foot to rest on it, once the footwear (1) is worn, and
said sole (3) is fixed to said upper portion (2) below and in correspondence with said deconstructed plantar area (4) and is provided with a plurality of flexible pads (5), arranged in correspondence with respective sensitive areas (6) for the foot reflexology massage.

2. Footwear (1) according to claim 1, wherein each of said flexible pads (5) is made of an elastic material such as to be compressed when subjected to pressure and to reacquire the original shape when said compression ends.

3. Footwear (1) according to claim 2, wherein each of said flexible pads (5) is realized through 3D printers using thermoplastic elastomers of the TPU 98A, TPE or TPC type or in pressurized air contained in plastic material bubbles; or again in E.V.A. (Ethylene Vinyl Acetate) by injection or compression.

4. Footwear (1) according to claim 1, wherein at least one flexible pad (5a) is arranged in said sole (3) in correspondence of the sensitive area (6a) for reflexology foot massage in the front part of the foot sole, which is an area sensitive to the brain and cerebellum; at least one flexible pad (5b) is arranged in said sole (3) in correspondence of the sensitive area (6b) for reflexology foot massage in the upper part of the foot sole, which is an area sensitive to the solar plexus and lungs; at least one flexible pad (5c) is arranged in said sole (3) in correspondence of the sensitive area (6c) for reflexology foot massage in correspondence of the plantar arch, which is an area sensitive to the digestive apparatus; and at least one flexible pad (5d) is disposed in said sole (3) in correspondence of the sensitive area (6d) for reflexology foot massage in the posterior part of the foot sole, which is an area sensitive to the back and sciatic nerve.

5. Footwear (1) according to claim 4, wherein each of said flexible pads (5a,5b,5c,5d) occupies substantially the whole width of said sole (3), respectively in correspondence with said sensitive areas (6a, 6b, 6c, 6d) for reflexology foot massage.

6. Footwear (1) according to claim 1, wherein said flexible pads are separated from each other so that there is an empty space between a flexible pad (5) and the other.

7. Footwear (1) according to claim 1, wherein said upper portion (2) consists of a sort of bag/sock (7) provided with an opening (8) at one of its ends to allow insertion of the foot in the bag/sock (7) through said opening (8) and the wrapping of the whole foot in the bag/sock (7).

8. Footwear (1) according to claim 1, wherein the entire upper portion (2), including the plantar area (4), is made of soft and flexible materials.
